(19) United States
(12) Patent Application Publication
(10) Pub. No.: US 2005/0208302 A1
(43) Pub. Date: Sep. 22, 2005

(54) One-dimensional nanomaterial/phosphor heterostructure, method for the preparation thereof, and device

(76) Inventors: Gyu Chul Yi, Pohang-city (KR); Sug Woo Jung, Pohang-city (KR)

Correspondence Address: MARSHALL, GERSTEIN & BORUN LLP, 233 S. WACKER DRIVE, SUITE 6300, SEARS TOWER, CHICAGO, IL, 60606, US

(21) Appl. No.: 11/052,350

(22) Filed: Feb. 7, 2005

(30) Foreign Application Priority Data
Feb. 9, 2004 (KR) 10-2004-0008210

(51) Int. Cl. B05D 5/06; B32B 5/16

(52) U.S. Cl. 428/402; 427/64; 427/77; 977/DIG. 1

(57) ABSTRACT

The present invention relates to a nano-material/phosphor hetero-structure including a phosphor coated on a one-dimensional nano-material.

### BACKGROUND OF THE INVENTION

The present invention relates to a one-dimensional nano-material/nano-phosphor hetero-structure, and more particularly to a one-dimensional nano-material/nano-phosphor hetero-structure capable of being used for various nano-analysis and diagnosis of bio-materials, and also capable of being used as a light source by using a nano-material light emitting device, and a method of preparing the same.

Continuous development of new materials and semiconductor technology entailing higher integration and smaller size of semiconductor device has reached the limit of conventional top-down art such as lithography. Therefore, there is a need for a shift from a top-down approach to a bottom-up approach in order to develop a new nano-material that has a desired function at the atomic or molecular level. The preparation of new nano-material in the bottom-up approach necessarily requires the development of a technology capable of realizing a nano-structure that has the desired function in a material.

In order to prepare a white light source, there has been research on a method of preparing white light source by binding a phosphor on a ultra-violet light emitting device chip, and another method of preparing a white light emitting device by binding three different colors of light emitting source, such as red, green, and blue, by using an ultraviolet or blue light emitting diode belonging to a nitride-semiconductor group. However, these conventional methods based on nitride-semiconductor group involve formation of a thin film at high growth temperature so they are not economically efficient when prepared into white light. Furthermore, it is impossible to embody the highly efficient green emission device. In order to overcome this problem, the present invention embodies a new structure of coating a phosphor on semiconductor nano-rods. There is a need to simplify the structure and improve the photoluminescent intensity by using nano-structures in the construction of single white light emitting nano-devices.

Nano-crystals in the shape of CdSe- or CdS-based quantum dots are being used as diagnostic material for the detection of bio-materials, such as a proteins, cancer cells, viruses, and so on. However, it has the disadvantages of containing a highly toxic substance such as Cd, having a small surface area to which reagent can attach to, and having a photoluminescent spectrum that is sensitive to and dependent on the size of the quantum dots. Therefore, there is an urgent need for the development of a nontoxic material with a larger surface area capable of attaching a phosphor with a particular photoluminescent spectrum thereto.

### SUMMARY OF THE PRESENT INVENTION

An aspect of the present invention is to provide a nano-material/phosphor hetero-structure comprising a single nano-structure and a method of preparing the same.

Another aspect of the present invention is to provide a nano-material/phosphor hetero-structure with highly-improved photoluminescent effects by enlarging the surface area of a phosphor coated on a one-dimensional nano-material and a method of preparing the same.

In order to accomplish the aforementioned aspects, the present invention provides a nano-material/phosphor hetero-structure including a nano-phosphor coated on the surface of a one-dimensional nano-material or a nano-material arranged on a substrate.

The present invention also provides a method of preparing the aforementioned nano-material/phosphor hetero-structure including arranging a nano-material on a substrate, and coating the surface of the above nano-material with a nano-phosphor.

### BRIEF DESCRIPTION OF THE DRAWINGS

FIG. 1A is a schematic drawing of a nano-material/phosphor hetero-structure coated with a phosphor on the tip of a one-dimensional nano-material according to an exemplary embodiment of the present invention;

FIG. 1B is another schematic drawing of a nano-material/phosphor hetero-structure coated with a phosphor on the entire surface of a nano-material;

FIG. 2A is a schematic drawing of a nano-material/phosphor hetero-structure coated with a multi-layered phosphor structure on the tip surface of a nano-material according to another exemplary embodiment of the present invention;

FIG. 2B is another schematic drawing of a nano-material/phosphor hetero-structure coated with a multi-layered phosphor structure on the entire surface of a nano-material;

FIG. 3 is a schematic process diagram of preparing a nano-material/phosphor hetero-structure coated with a phosphor on the tip surface of a nano-material arranged on a substrate along one direction according to a third embodiment of the present invention;

FIG. 4A is a schematic process diagram for preparing a nano-material/phosphor hetero-structure coated with a multi-layered phosphor structure on the tip surface of a nano-material arranged on a substrate along one direction according to a fourth embodiment of the present invention;

FIG. 4B is a schematic process diagram for preparing a nano-material/phosphor hetero-structure coated with a multi-layered phosphor structure on the entire surface of a nano-material arranged on a substrate along one direction according to a fourth embodiment of the present invention;

FIG. 5A is a schematic process diagram for preparing a nano-material/phosphor hetero-structure simultaneously coated with two different phosphors on the tip surface of a nano-material arranged on a substrate along one direction according to a fifth embodiment of the present invention;

FIG. 5B is a schematic process diagram for preparing a nano-material/phosphor hetero-structure coated with two different phosphors on the entire surface of a nano-material arranged on a substrate along one direction according to a fifth embodiment of the present invention;

FIG. 6 is a schematic process diagram for preparing a phosphor/magnetic material/nano-material hetero-structure coated first with a nano-magnetic material and next with a nano-phosphor on the surface of a nano-material according to a sixth embodiment of the present invention;

FIG. 7A is a SEM photograph of a zinc oxide nano-rod before having a nano-phosphor according to Example 1 of the present invention deposited thereon;

FIG. 7B is another SEM photograph of a zinc oxide nano-rod deposited with Y₂O₃:Eu; and

FIG. 8 is a photoluminescence spectrum of a ZnS (Ag, Al)/zinc oxide, ZnS (Cu, Al)/zinc oxide, and Y₂O₃:Eu/zinc oxide hetero-structure prepared according to Examples 1 to 3.

### DETAILED DESCRIPTION OF THE INVENTION

The present invention provides a nano-material/phosphor hetero-structure including a phosphor coated on the surface of a one-dimensional nano-material.

In this specification, “nano-material” refers to material having a diameter or thickness within the range of several to several hundreds of nanometers and length within the range of several to several hundreds of micrometers, and is preferably 100 nm or less in thickness and tens of micrometers or less in length. A nano-phosphor is defined as being in the aforementioned range. In addition, “one dimensional” is defined as having a linear form.

According to the present invention, the aforementioned nano-material may include, but is not limited to, nano-rods, nano-tubes, nano-wires, and nano-needles.

The aforementioned phosphor can be optionally coated on either the tip or side surface of a nano-material or on the entire surface thereof. Then, with the formation of interface between the phosphor and the nano-material, a nano-material/phosphor hetero-structure can be prepared.

The aforementioned phosphor layer can be coated in a multi-layered or a multi-walled structure.

It can also be coated on a nano-material bound with a nano-magntic material.

In addition, the coated phosphor can be a red, green, or blue phosphor or a mixture thereof, or an oxide phosphor or a sulfide phosphor or a mixture thereof.

A nano-material/phosphor hetero-structure of the present invention can be usefully applied to a display, a white light source, a probe, and various recording media, as well as to a light emitting device.

It can also be used to diagnose bio-materials such as proteins, cancer cells, viruses, and so on.

The present invention is described in further detail below.

A nano-material for a nano-material/phosphor hetero-structure in the present invention may include, but is not limited to, a Group 111-Group V element-containing compound, a Group II-Group IV element-containing compound, a silicon semiconductor, carbon nano-tube, or a combination thereof. A more detailed example are ZnO, GaN, Si, InP, InAs, GaAs, Ge, carbon nano-tube, or a combination thereof. Furthermore, one or more material selected from the group consisting of Mg, Cd, Ti, Li, Cu, Al, Ni, Y, Ag, Mn, V, Fe, La, Ta, Nb, Ga, In, S, Se, P, As, Co, Cr, B, N, Sb, and H can be additionally included.

The present invention has no particular limits to the kind of phosphor used as long as it is nano-sized. However, a phosphor containing a rare earth element or a transition element can be preferably used in the present invention. The aforementioned phosphor may be an oxide or a sulfide. For example, it can be a combination of a red phosphor such as CaS:Eu, ZnS:Sm, Y₂O₂S:Eu, Gd₂O₃:Eu, Y₂O₃:Eu, and the like, a green one such as ZnS:Tb, ZnS:(Cu,Al), ZnS:Ce, Cl, Gd₂O₂S:Tb, SrGa₂S₄:Eu, Y₂SiO₅:Tb, and the like, a blue one such as SrS:Ce, ZnS:Tm, YSiO₅:Ce, ZnS:(Ag,Al), and the like, white light such as YAG (Yttrium Aluminum Garnet), and various oxides and sulfides. The method of coating nano-phosphor onto a nano-material may include, but is not limited to, any common dry or wet method. The above dry coating methods include chemical vapor deposition (CVD), as well as a physical growth methods such as sputtering, thermal or e-beam evaporation, pulse laser deposition, and molecular beam epitaxy. The above wet coating methods include various methods such as the sol-gel method, spin coating, dip coating, and so on. It is preferable to dry and remove the solvent after wet coating.

After the aforementioned coating process, a hetero-structure deposited with a nano-phosphor on a nano-material can be heat treated to improve its photoluminescent efficiency, if necessary. The heat treatment can be performed under an oxidizing atmosphere such as oxygen, air, and so on, under an inert atmosphere such as argon, or under a reducing atmosphere such as nitrogen, hydrogen, or a mixture thereof.

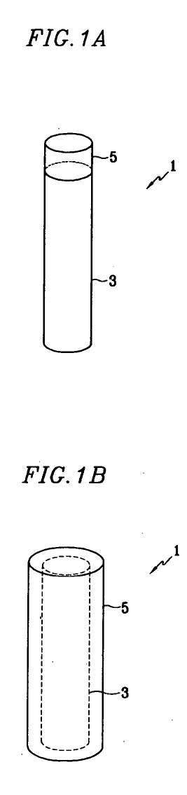

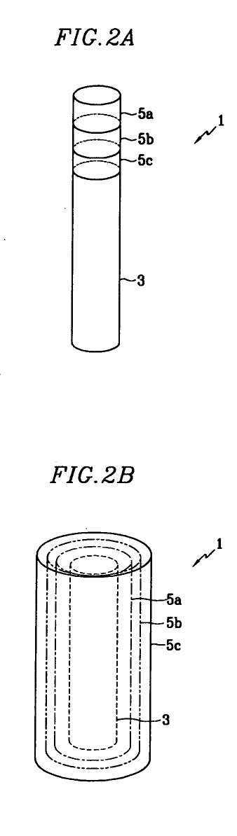

FIG. 1A is a schematic drawing of a one-dimensional nano-material/phosphor hetero-structure 1 coated with a phosphor 5 on the surface of a part (tip) of a one-dimensional nano-material 3 according to a preferred embodiment of the present invention. FIG. 1B is a schematic drawing of a phosphor/one-dimensional nano-material hetero-structure coated with a phosphor 5 on the entire surface of a one-dimensional nano-material 3. The aforementioned phosphor can be a red, green, or blue phosphors or a mixture thereof, or an oxide phosphor, a sulfide phosphor, or a mixture thereof.

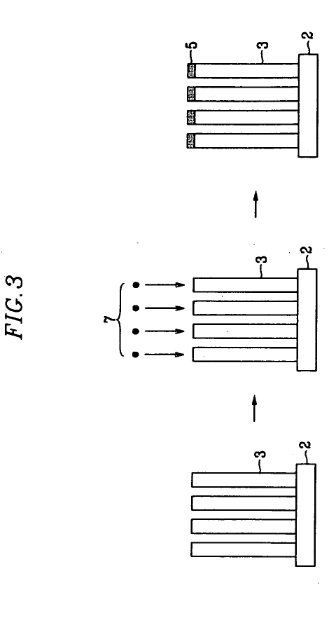

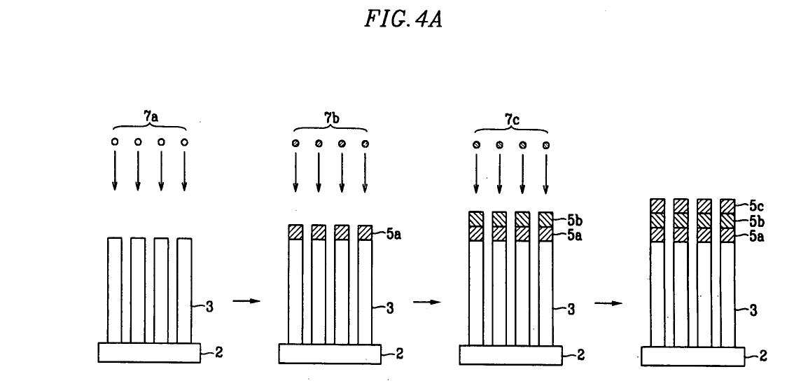

FIG. 2A is a schematic drawing of a nano-material/phosphor hetero-structure 1 coated with phosphors Sa, Sb, Sc in a multi-layered structure on the tip surface of a nano-material 3, while FIG. 2B is a schematic drawing of a nano-material/phosphor hetero-structure 1 coated with phosphors Sa, Sb, Sc in a multi-layered structure on the entire surface of a nano-material 3 according to another preferred embodiment of the present invention. Although FIGS. 2A and 2B show examples where three phosphors form a multi-layered structure, but it goes without saying that the present invention includes cases where two or more than three phosphors are layered.

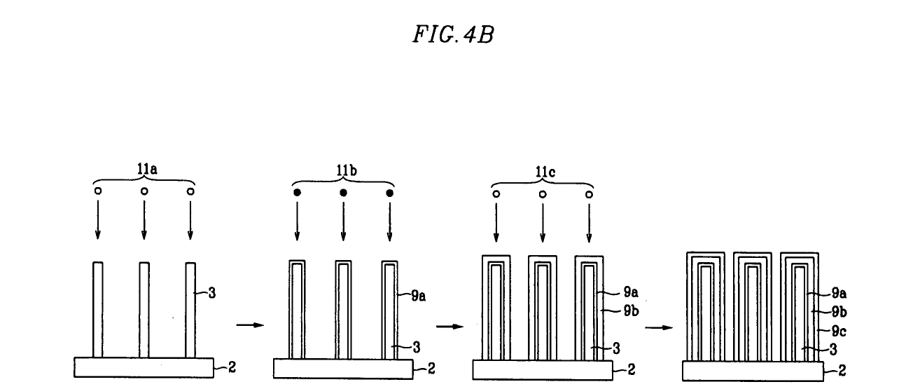

According to an embodiment of the present invention, a phosphor can be coated after arranging the aforementioned nano-material on a substrate. As shown in FIG. 3, a phosphor 5 can be coated onto the surface of a nano-material 3 arranged on a substrate 2. The aforementioned substrate can be glass, silicon, alumina, and so on.

It is preferable for the aforementioned nano-material to be arranged at an angle of 45° to 90° to the surface of the substrate, and more preferable to be arranged at right angles to the surface of the substrate.

In order to attach the nano-material on the substrate 2, various deposition methods can be used. For example, a zinc oxide nano-material can be prepared by an metal organic chemical vapor deposition method, where a nano-material is deposited and grown on the substrate by putting a zinc-containing metal organic compound and an oxygen-containing gas or an oxygen-containing organic material into the reactor, and reacting at a temperature of 1,200° C. or less and at normal pressure or less.

This kind of metal organic chemical vapor deposition makes it easy to prepare hetero-structures with a variety of deposited materials, there is no possibility of leaving a metal catalyst residue on the tip of the nano-material since metal catalysts are not used, and it enables nano-material to grow along one direction in uniform thickness and length and allows control of the diameter to be under 200 nm and preferably down to several nanometers. FIG. 3 is a schematic process diagram of preparing a phosphor/one-dimensional nano-material hetero-structure with a phosphor layer 5 by coating a phosphor 7 on the tip of a nano-material 3 along one direction grown and arranged on the substrate 2 according to another embodiment of the present invention

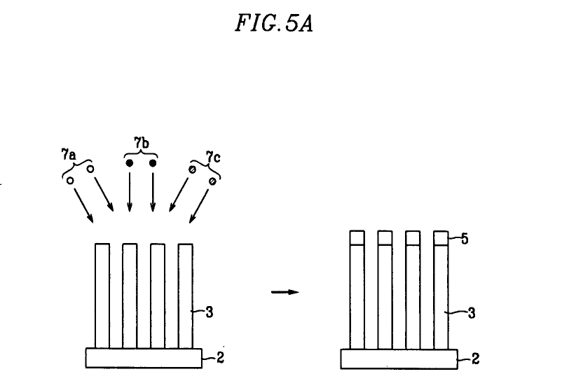

As shown in FIG. 4A, the aforementioned phosphor layer 5 can be formed in multi-layers 5a, 5b, 5c by laminating several nano-phosphors 7a, 7b, 7c on the tip of a nano-material 3. A nano-phosphor layer with a laminated structure like this is formed by a method of coating and depositing a nano-phosphor exclusively on the tip of a nano-material by irradiating the plume vertically in laser ablation, so that each phosphor will grow there first. This method leads to the preparation of a nano-material/nano-phosphor hetero-structure wherein a nano-phosphor is laminated in a multi-layered structure on the tip of a nano-material. The aforementioned nano-phosphor can include a red, green, or blue phosphor, or a combination thereof, or an oxide, a sulfide, or a mixture thereof.

As shown in FIG. 4B, nano-phosphor layers 9a, 9b, 9c can also be formed by sequentially coating nano-phosphors 11a, 11b, 11c on the entire surface of a nano-material arranged on a substrate 2. FIG. 4B shows a schematic process diagram of preparing a hetero-structure wherein a nano-phosphor layer is formed in a multi-walled structure by coating a nano-phosphor on the entire surface of the nano-material formed on a substrate. The aforementioned nano-phosphor may include a red, green, or blue phosphor, or a combination thereof, or an oxide, a sulfide, or a mixture thereof. The preparation of the aforementioned phosphor layer with a multi-walled structure by laminating a nano-phosphor on the entire surface of a nano-material can be prepared by spinning the specimen mounted at an angle during pulsed laser vapor deposition of a thin film and maintaining a uniform plume flow in every direction of the nano-rods for uniform growth of the phosphor layer. In addition, the nano-phosphor can be uniformly deposited on the entire surface of a nano-material if a reaction material in a gaseous state is used, such as in chemical vapor deposition, and the like.

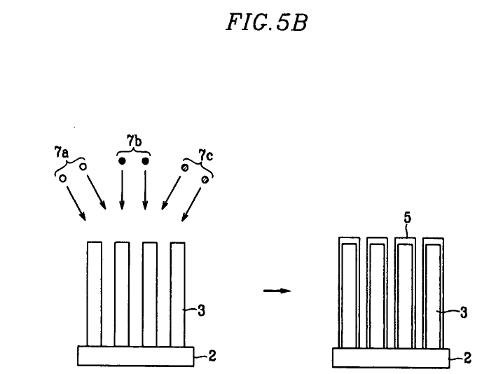

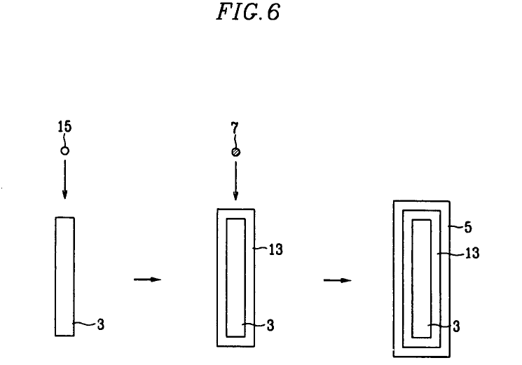

FIG. 5A shows a phosphor layer 5 formed by simultaneously laminating several phosphors 7a, 7b, 7c on the tip of a nano-material 3. The aforementioned phosphors can be selected from three different color phosphors such as red, green, or blue, or a combination thereof.

As shown in FIG. 5B, several different phosphors 7a, 7b, 7c can be coated on the entire surface of a nano-material 3 to form a heterojunction phosphor layer. The aforementioned phosphors can be selected from three different color phosphors such as red, green, or blue, or a combination thereof.

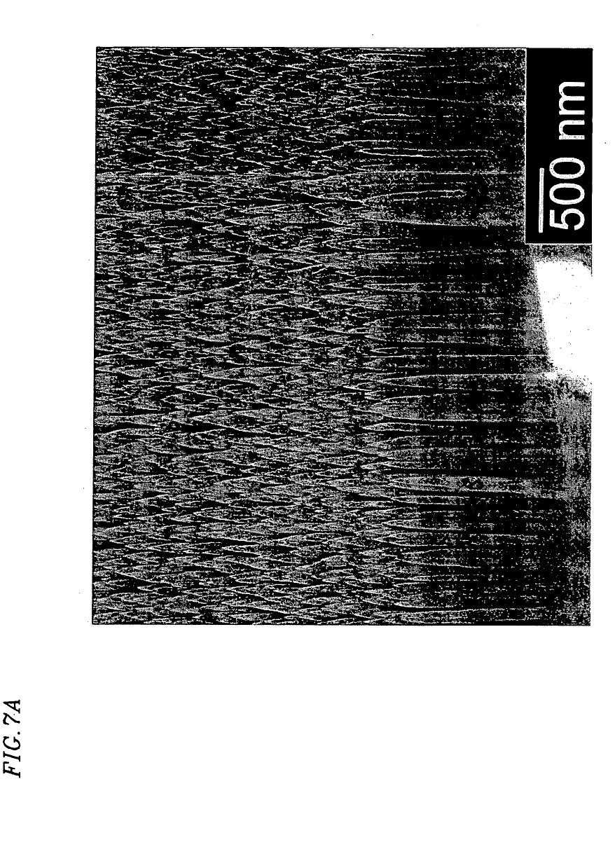

In addition, as shown in FIG. 6, a phosphor/magntic magterial/nano-material hetero-structure can be prepared by forming a phosphor layer 5 by coating a phosphor 7 on the surface of a nano-material 3 after first forming a magnetic material layer 13 by coating a magnetic material 15 thereon. The aforementioned magnetic material can be an oxide, such as Fe₂O₃, as well as a single metal such as Fe, Co, Ni, or alloys, or a nano-size single-magnetic metal.

According to the present invention, a light source emitting red, green, or blue light can be obtained by using oxides, sulfides, or organic phosphors that are red, green, or blue in color, and white light can be obtained by depositing a combination of the above red, green, and blue photoluminescent material on the surface of a nano-material. Accordingly, the present invention can improve the function of a photoluminescent(light emitting) device, including a white light photoluminescent(light emitting) device, by establishing a nano-material/nano-phosphor hetero-structure on a nano-material.

The nano-material/phosphor hetero-structure of the present invention can be applied to various light devices or electronic devices by coating a phosphor on the large surface area of a one-dimensional nano-material. In particular, a phosphor with a larger surface area can have greatly increased photoluminescent intensity, and can be used in various photoluminescent diodes, such as a white light source.

From here on, the present invention is illustrated in further detail based on the following examples. However, the following examples only illustrate the present invention, and it goes without saying that the present invention is not limited thereto.

### (EXAMPLES 1 to 3)

Zinc oxide nano-rods were grown on an A1₂O₃ substrate by the metal organic chemical vapor deposition method. Dimethyl zinc and O₂ were used as reaction material and argon was used as the transporting gas. The aforementioned O₂ and dimethyl zinc gas were put into each reactor through separate individual paths where their flow speeds were regulated within the range of 20 to 100 sccm and 1 to 10 sccm respectively. Zinc oxide nano-rods were deposited and grown on the substrate by chemically reacting the precursor of the aforementioned reaction material in the reactor. The pressure was maintained at 1 to 760 torr and the temperature at 200 to 700° C. in the reactor during the approximately one-hour period in which the nano-rods were grown.

Next, 1) a ZnS:(Cu,Al) phosphor (Example 1), 2) a ZnS:(Ag,Al) phosphor (Example 2), and 3) an Y₂O₃:Eu phosphor (Example 3) were deposited onto the nano-rods in a thickness of 100 to 500 nm through laser molecular beam epitaxy. The deposition process was done by starting the laser ablation after vacuum pumping the chamber with a turbo molecular pump (TMP) down to a pressure of 10-7 torr, and then, sufficiently stabilizing the sample by maintaining it for about 10 minutes at the desired growth temperature. Here, the temperature for the growth was regulated within the wide range between room temperature to hundreds of degrees.

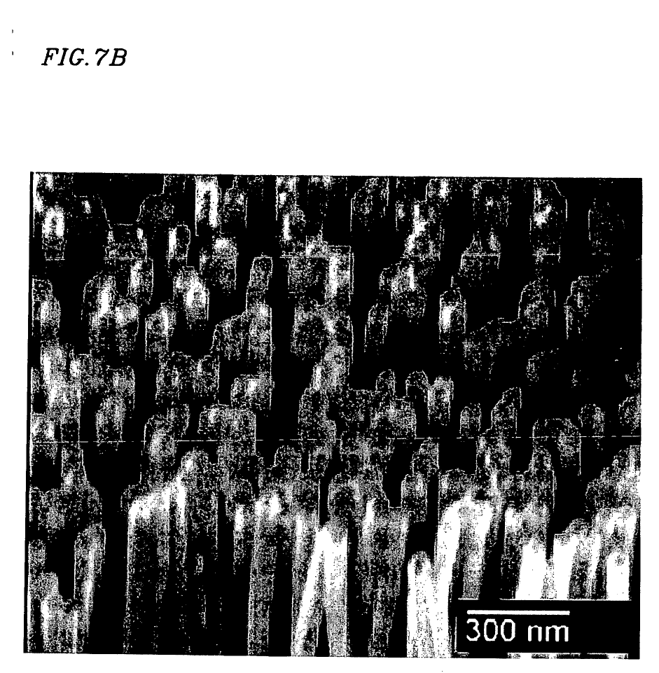

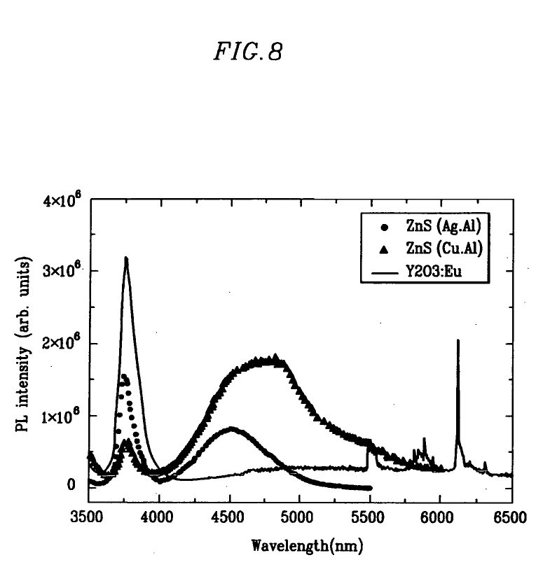

FIG. 7A is a SEM photograph of zinc oxide nano-rods before the deposition of nano-phosphor, and FIG. 7B is a SEM photograph of zinc oxide nano-rods deposited with Y₂O₃:Eu nano-phosphor. Comparing 7A with 7B, it can be seen that the nano-phosphor is selectively deposited on the tip of the nano-rods so that the diameter or shape of the nano-rods is not changed much. In addition, the nano-phosphor can be made to form a heterojunction on the entire surface of the nano-material as well as be made to selectively deposit on the tip.

The photoluminescence of zinc oxide nano-rods deposited with a phosphor of Y₂O₃:Eu, ZnS (Ag, Al), or ZnS (Cu, Al) prepared according to Examples 1 to 3, was measured to evaluate their optical properties. Here, a He-Cd laser with a wavelength of 325 nm was used as a source. FIG. 8 illustrates the photoluminescent property of Y₂O₃:Eu, ZnS (Ag, Al), and ZnS (Cu, Al) phosphors selectively deposited on zinc oxide nano-rods. FIG. 8 shows that in a nano-material/nano-phosphor hetero-structure prepared according to the present invention, the phosphor deposited in a single nano-structure on a single nano-material fully displays its unique properties.

A nano-material/phosphor hetero-structure of the present invention prepared by using the larger surface area of a one-dimensional material has the potential of application to a variety of devices and materials due to the larger area of light emission. The possibility of great increase in the photoluminescent intensity of a phosphor with a larger surface area, especially allows its use as a photoluminescent diode device, such as a white light source, or a bio-diagnostic device.

Although the present invention has been described in detail hereinabove in connection with certain exemplary embodiments, it should be understood that the invention is not limited to the disclosed embodiments, but is intended to cover various modifications that may be made within the spirit and scope of the present invention by one of ordinary skill in the art.

1. A nano-material/phosphor hetero-structure comprising
a one-dimensional nano-material comprising at least one of a tip and a surface; and
a phosphor coated on a the tip or an on the entire surface of the nano-material

2. The nano-material/phosphor hetero-structure of claim 1, wherein the nano-material is arranged against a surface of a substrate at an angle of 45° to 90°.

3. The nano-material/phosphor hetero-structure of claim 1, wherein the nano-material is in the form of a nano-rod, nano-tube, nano-wire, or nano-needle.

4. The nano-material/phosphor hetero-structure of claim 1, wherein the nano-material is selected from the group consisting of a Group II-VI element-containing compound, a Group Ill-V element-containing compounds, a silicon-based semiconductors, and carbon nano tubes.

5. The nano-material/phosphor hetero-structure of claim 4, wherein the nano-material further comprises at least one material selected from the group consisting of Mg, Cd, Ti, Li, Cu, Al, Ni, Y, Ag, Mn, V, Fe, La, Ta, Nb, Ga, In, S, Se, P, As, Co, Cr, B, N, Sb, and H.

6. The nano-material/phosphor hetero-structure of claim. 1, wherein the nano-material is a nano-rod in the range of 1 nm to 1000 nm in diameter and 10 nm to 100 μm in length.

7. The nano-material/phosphor hetero-structure of claim 1, wherein the phosphor is selected from the group consisting of oxides and sulfides comprising at least one of a transition element and a rare earth-element, and mixtures thereof, and
the phosphor is one or more selected from the group consisting of a red phosphors, green phosphors, blue phosphors, and combinations thereof.

8. The nano-material/phosphor hetero-structure of claim 1, wherein the nano-phosphor is laminated in a multi-layered structure.

9. The nano-material/phosphor hetero-structure of claim 1, wherein the nano-phosphor is two or more of a red phosphor, a green phosphor, or a blue phosphor combined and coated simultaneously.

10. The nano-material/phosphor hetero-structure of claim 1, wherein the hetero-structure further comprises a nano-magnetic material to form a nano-phosphor/magnetic material/nano-material.

11. A method of preparing a nano-material/phosphor hetero-structure comprising:
forming a nano-material by growing a nano-material on a substrate along one direction; and
coating a nano-phosphor on a surface of the nano-material.

12. The method of preparing a nano-material/phosphor hetero-structure of claim 11, wherein the nano-material defines a tip and the method comprises coating the phosphor on the tip of the nano-material.

13. The method of preparing a nano-material/phosphor hetero-structure of claim 11, wherein the nano-material is selected from the group consisting of a Group II-VI element-containing compounds, a Group III-V element-containing compounds, a silicon-based semiconductors, and carbon nano tubes.

14. The method of preparing a nano-material/phosphor hetero-structure of claim 11, wherein the nano-material further comprises at least one material selected from the group consisting of Mg, Cd, Ti, Li, Cu, Al, Ni, Y, Ag, Mn, V, Fe, La, Ta, Nb, Ga, In, S, Se, P, As, Co, Cr, B, N, Sb, and H.

15. The method of preparing a nano-material/phosphor hetero-structure of claim 11, wherein the phosphor is selected from the group consisting of oxides and sulfides comprising at least one of a transition element and a rare earth element, and a mixture thereof, and
the phosphor is one or more selected from the group consisting of a red phosphors, green phosphors, and blue phosphors, and a combinations thereof.

16. The method of preparing a nano-material/phosphor hetero-structure of claim 11, comprising coating the nano-phosphor using a method selected from the group consisting of sputtering, thermal evaporation, e-beam evaporation, pulse laser deposition, molecular beam epitaxy, chemical vapor deposition (CVD), sol-gel coating, and spin coating.

17. The method of preparing a nano-material/phosphor hetero-structure of claim 11, further comprising heat treating after coating the nano-phosphor.

18. The method of preparing a nano-material/phosphor hetero-structure of claim 11, comprising laminating the nano-phosphor in a multi-layered structure.

19. The method of preparing a nano-material/phosphor hetero-structure of claim 11, wherein the nano-material defines a surface and the method comprises coating the phosphor on the entire surface of the nano-material.

20. A device comprising a nano-material/nano-phosphor hetero-structure comprising:
a nano-material grown on a substrate along one direction; and
a nano-phosphor coated on a surface of the nano-material.
